(19) United States
(12) Patent Application Publication
(10) Pub. No.: US 2008/0177623 A1
(43) Pub. Date: Jul. 24, 2008

(54) Monitoring User Interactions With A Document Editing System

(76) Inventors: Juergen Fritsch, Pittsburgh, PA (US); Detlef Koll, Pittsburgh, PA (US); Kjell Schubert, Pittsburgh, PA (US); Christopher M. Currivan, Pittsburgh, PA (US)

Correspondence Address: ROBERT PLOTKIN, PC, 45 BUTTERNUT CIRCLE, CONCORD, MA, 01742-1937, US

(21) Appl. No.: 12/018,453

(22) Filed: Jan. 23, 2008

Related U.S. Application Data
(60) Provisional application No. 60/886,487, filed on Jan. 24, 2007.

(51) Int. Cl. G06Q 10/00

(52) U.S. Cl. 705/11

(57) ABSTRACT

A human editor uses a document editing system to edit a draft document. The editor's editing behavior is monitored and logged. Statistics are developed from the log to produce an assessment of the editor's productivity. This assessment, in combination with assessments of other editors, may be used to develop behavioral metrics which indicate correlations between editing behaviors and productivity. The behavioral metrics may be used to identify including the relative contribution to efficient editing of different editing behaviors. Such information about individual editing behaviors may be used to evaluate the productivity of individual editors based on their editing behaviors, to identify behaviors which individual editors could adopt to improve their productivities, and to identify changes to the editing system itself for improving editor productivity. An editor's editing behavior may be “played back” and observed by a human in an attempt to identify the causes of the editor's poor productivity.

### CROSS REFERENCE TO RELATED APPLICATIONS

This application claims priority from commonly-owned U.S. Prov. Pat. App. Ser. No. 60/886,487, filed on Jan. 24, 2007, entitled, “Monitoring User Interactions With A Document Editing System,” hereby incorporated by reference herein.

This application is related to commonly-owned U.S. patent application Ser. No. 10/923,517, filed on Aug. 20, 2004, entitled, “Automated Extraction of Semantic Content and Generation of a Structured Document from Speech,” hereby incorporated by reference herein.

### BACKGROUND

It is desirable in many contexts to generate a structured textual document based on human speech. In the legal profession, for example, transcriptionists transcribe testimony given in court proceedings and in depositions to produce a written transcript of the testimony. Similarly, in the medical profession, transcripts are produced of diagnoses, prognoses, prescriptions, and other information dictated by doctors and other medical professionals. Transcripts in these and other fields typically need to be highly accurate (as measured in terms of the degree of correspondence between the semantic content (meaning) of the original speech and the semantic content of the resulting transcript) because of the reliance placed on the resulting transcripts and the harm that could result from an inaccuracy (such as providing an incorrect prescription drug to a patient). It may be difficult to produce an initial transcript that is highly accurate for a variety of reasons, such as variations in: (1) features of the speakers whose speech is transcribed (e.g., accent, volume, dialect, speed); (2) external conditions (e.g., background noise); (3) the transcriptionist or transcription system (e.g., imperfect hearing or audio capture capabilities, imperfect understanding of language); or (4) the recording/transmission medium (e.g., paper, analog audio tape, analog telephone network, compression algorithms applied in digital telephone networks, and noises/artifacts due to cell phone channels).

For example, referring to FIG. 1, a dataflow diagram is shown of a prior art system 100 for transcribing and editing documents. The system 100 includes a transcription system 104, which produces a draft document 106 based on a spoken audio stream 102. A human editor 112, such as a medical language specialist (MLS), provides editing commands 114 to a document editing system 108 to produce an edited version 110 of the document 106. To assist in the editing process, the document editing system 108 provides output 116 to the human editor 112, such as a display of the contents of the draft document 106 as it is being edited by the editor 112.

The draft document 106, whether produced by a human transcriptionist or an automated speech recognition system, may therefore include a variety of errors. Typically it is necessary for the human editor 112 to proofread and edit the draft document 106 to correct the errors contained therein. Transcription errors that need correction may include, for example, any of the following: missing words or word sequences; excessive wording; mis-spelled, -typed, or -recognized words; missing or excessive punctuation; and incorrect document structure (such as incorrect, missing, or redundant sections, enumerations, paragraphs, or lists).

Such error correction can be tedious, time-consuming, costly, and itself error-prone. What is needed, therefore, are techniques for improving the efficiency and accuracy with which errors are corrected in draft documents.

### SUMMARY

A human editor uses a document editing system to edit a draft document, such as a document produced from recorded speech either by a human transcriber or an automatic document generation system. The editor's editing behavior is monitored and logged. Statistics are developed from the log to produce an assessment of the editor's productivity. This assessment, in combination with assessments of other editors, may be used to develop behavioral metrics which indicate correlations between editing behaviors and productivity. The behavioral metrics may be used to identify behaviors that are either detrimental or conducive to efficient editing, including the relative contribution to efficient editing of each editing behavior. Such information about individual editing behaviors may be used to evaluate the productivity of individual editors based on the editing behaviors in which they engage, to identify behaviors which individual editors could adopt to improve their productivities, and to identify changes to the editing system itself for improving editor productivity. In cases where automatic identification of the causes of poor productivity proves difficult or impossible, an editor's editing behavior may be “played back” from the recorded edit log and observed by a human in an attempt to identify the causes of the editor's poor productivity.

For example, in one embodiment of the present invention, a computer-implemented method is provided for use with a document editing system and a first plurality of documents. The method includes: (a) identifying first actual editing behavior applied by a user to the document editing system to edit the first plurality of documents; (B) deriving a statistic from the first identified editing behavior; and (C) identifying potential editing behavior, suitable for application by the user to the document editing system to edit the documents, based on the derived statistic.

In another embodiment of the present invention, a computer-implemented method is provided for use with a document editing system and a plurality of documents. The method comprises: (A) identifying actual editing behavior applied by a user to the document editing system to edit the plurality of documents; and (B) identifying a modification to the document editing system based on the actual editing behavior.

In yet another embodiment of the present invention, a computer-implemented method is provided for use with a document editing system and a plurality of documents. The method includes: (A) identifying actual editing behavior applied by a user to the document editing system to edit the plurality of documents; and (B) determining whether the actual editing behavior satisfies a plurality of predetermined criteria for preferred user editing behavior, the plurality of predetermined criteria comprising: (1) an efficiency criterion defining a minimum efficiency threshold for editing behavior; and (2) an accuracy criterion defining a minimum accuracy threshold for editing behavior.

In a further embodiment of the present invention, a computer-implemented method is provided for use with a document editing system and a plurality of documents. The method comprises: (A) identifying a presentation of recorded actual editing behavior applied by a user to the document editing system to edit the plurality of documents; and (B) determining whether the actual editing behavior satisfies at least one predetermined criterion for preferred user editing behavior based on the presentation.

In yet a further embodiment of the present invention, a computer-implemented method is provided for use with a document editing system and an original version of a document. The method comprises: (A) identifying actual editing behavior applied by a user to the document editing system to edit the original version of the document and thereby to produce an edited version of the document, the editing behavior having an original temporal profile; (B) recording the actual editing behavior to produce a record of the actual editing behavior; and (C) applying the actual editing behavior from the record to the document editing system in accordance with the original temporal profile to edit the original version of the document.

In another embodiment of the present invention, a computer-implemented method is provided for use with a document editing system and a first plurality of documents. The method comprises: (A) identifying first actual editing behavior of a predetermined type, applied by a first user to the document editing system to edit the first plurality of documents; (B) deriving a first productivity assessment of the first user from the first identified editing behavior; (C) identifying second actual editing behavior of the predetermined type, applied by a second user to the document editing system to edit the second plurality of documents; (D) deriving a second productivity assessment of the second user from the second identified editing behavior; and (E) deriving, from the first and second productivity assessments, a behavioral metric indicating a degree of correlation between editing behavior of the predetermined type and productivity.

Other features and advantages of various aspects and embodiments of the present invention will become apparent from the following description and from the claims.

### BRIEF DESCRIPTION OF THE DRAWINGS

FIG. 1 is a dataflow diagram of a prior art system for transcribing and editing documents;

FIG. 2 is a dataflow diagram of a system for editing a document according to one embodiment of the present invention;

FIG. 3 is a flowchart of a method performed by the system of FIG. 2 according to one embodiment of the present invention;

FIGS. 4A and 4B are dataflow diagrams illustrating the editing process of FIG. 2 in more detail;

FIG. 5 is a diagram illustrating the contents of an editing behavior log according to one embodiment of the present invention;

FIG. 6 is a flowchart of a method for developing a productivity assessment of a human editor according to one embodiment of the present invention;

FIG. 7 is a dataflow diagram of a system for performing the method of FIG. 6 according to one embodiment of the present invention;

FIG. 8 is a flowchart of a method for developing productivity assessments for multiple editors and then correlating those assessments with editing behaviors to identify degrees of correlation between editing behaviors and productivity according to one embodiment of the present invention;

FIG. 9 is a dataflow diagram of a system for performing the method of FIG. 8 according to one embodiment of the present invention;

FIG. 10 is a flowchart of a method for producing a behavioral assessment of a human editor according to one embodiment of the present invention;

FIG. 11 is a dataflow diagram of a system for performing the method of FIG. 10 according to one embodiment of the present invention; and

FIG. 12 is a graph of logged editing commands according to one embodiment of the present invention.

### DETAILED DESCRIPTION

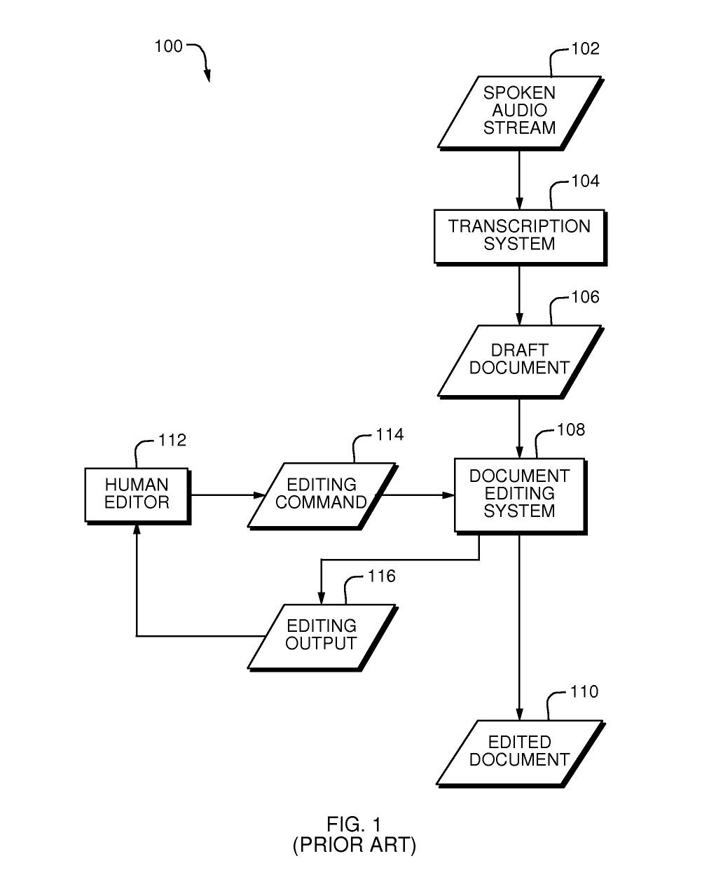

As described above with respect to FIG. 1, typically it is necessary for the human editor 112 to proofread and edit the draft document 106 to correct the errors contained therein. Such error correction can be tedious, time-consuming, costly, and itself error-prone. One may question, therefore, whether it would be more efficient for the human editor 112 to produce an error-free document simply by re-transcribing the spoken audio stream 102 from scratch, rather than by correcting errors in the draft document 106.

The extent of the productivity gains obtained by using the process shown in FIG. 1, in which errors are eliminated by editing the draft document 106 rather than by re-transcribing the spoken audio stream 102 from scratch, depends on the efficiency and accuracy of the editing process, represented in FIG. 1 by the interaction between the human editor 112 and the document editing system 108. This, in turn, depends not only on the skill of the human editor 112 but also on the productivity features provided by the document editing system 108. Embodiments of the present invention may be used to (a) improve the efficiency and accuracy of the document editing process, (b) perform targeted training of human editors, to achieve an overall increase in the efficiency and accuracy of the document transcription process.

A human editor uses a document editing system to edit a draft document, such as a document produced from recorded speech either by a human transcriber or an automatic document generation system. The editor's editing behavior is monitored and logged. Statistics are developed from the log to produce an assessment of the editor's productivity. This assessment, in combination with assessments of other editors, may be used to develop behavioral metrics which indicate correlations between editing behaviors and productivity. The behavioral metrics may be used to identify behaviors that are either detrimental or conducive to efficient editing, including the relative contribution to efficient editing of each editing behavior. Such information about individual editing behaviors may be used to evaluate the productivity of individual editors based on the editing behaviors in which they engage, to identify behaviors which individual editors could adopt to improve their productivities, and to identify changes to the editing system itself for improving editor productivity. In cases where automatic identification of the causes of poor productivity proves difficult or impossible, an editor's editing behavior may be “played back” from the recorded edit log and observed by a human in an attempt to identify the causes of the editor's poor productivity.

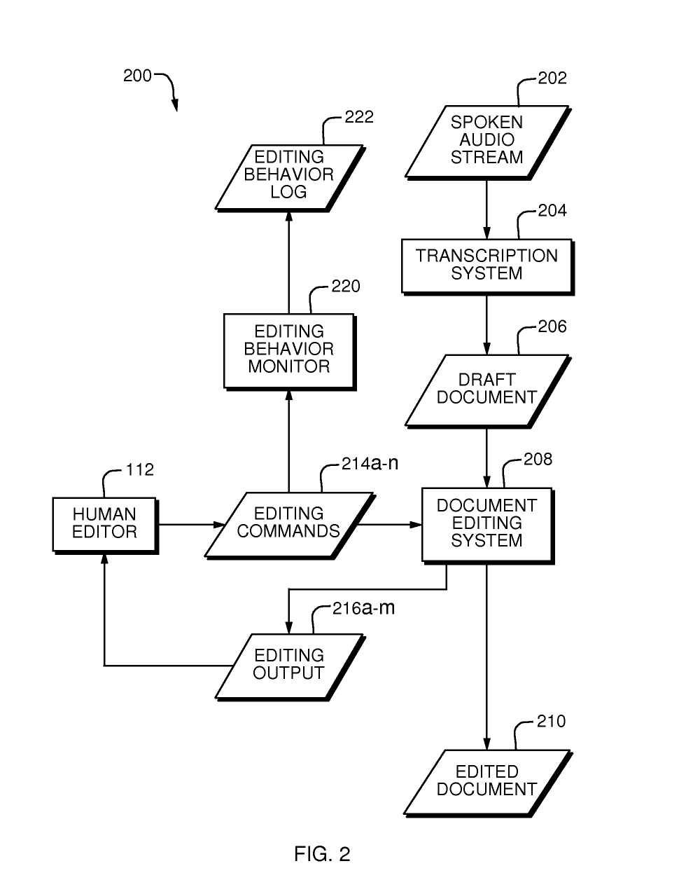

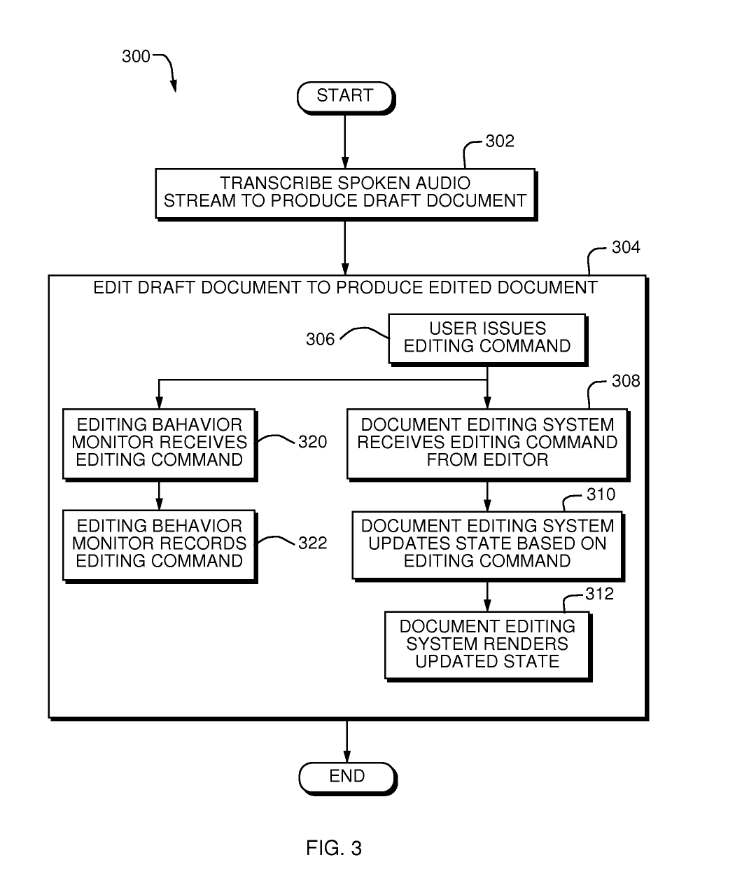

Referring to FIG. 2, a dataflow diagram is shown of a system 200 for transcribing and editing a document according to one embodiment of the present invention. Referring to FIG. 3, a flowchart is shown of a method 300 performed by the system 200 of FIG. 2 according to one embodiment of the present invention.

A transcription system 204 transcribes a spoken audio stream 202 to produce a draft document 206 (step 302). The spoken audio stream 202 may, for example, be dictation by a doctor describing a patient visit. The spoken audio stream 202 may take any form. For example, it may be a live audio stream received directly or indirectly (such as over a telephone or IP connection), or an audio stream recorded on any medium and in any format.

The transcription system 204 may produce the draft document 206 using a human transcriptionist, an automated speech recognizer, or any combination thereof. The transcription system 204 may, for example, produce the draft document 206 using any of the techniques disclosed in the above-referenced patent application entitled “Automated Extraction of Semantic Content and Generation of a Structured Document from Speech.” As described therein, the draft document 206 may, for example, be a literal (verbatim) transcript of the spoken audio stream 202 or other document representing speech in the spoken audio stream 202. In either case, the spoken audio stream 202 and the draft document 206 represent at least some content in common. As further described therein, although the draft document 206 may be a plain text document, the draft document 206 may also, for example, be a structured document, such as an XML document which delineates document sections and other kinds of document structure.

The draft document 206 may include a variety of errors. A human editor 212, such as a medical language specialist (MLS), provides a sequence of editing commands 214a-n to a document editing system 208 to produce an edited version 210 of the document 206 (step 304). Reference numeral 214 is used generally herein to refer to the editing commands 214a-n collectively, while reference numerals such as 214a and 214b are used to refer to individual ones of the editing commands 214a-n, where n is the number of editing commands 214a-n.

The editor 212 may provide the editing commands 214, for example, in an attempt to eliminate errors from the draft document 206. To assist in the editing process, the document editing system 208 provides output 216 to the human editor 212, such as an audio playback of the audio stream 202 and a display of the contents of the draft document 206 as it is being edited by the editor 212.

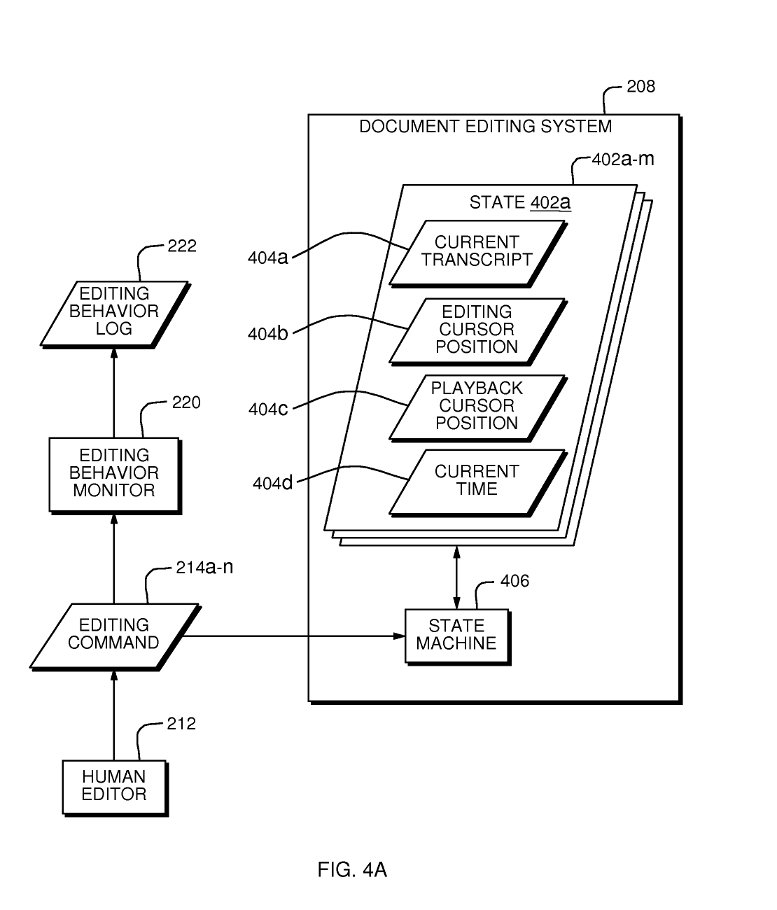

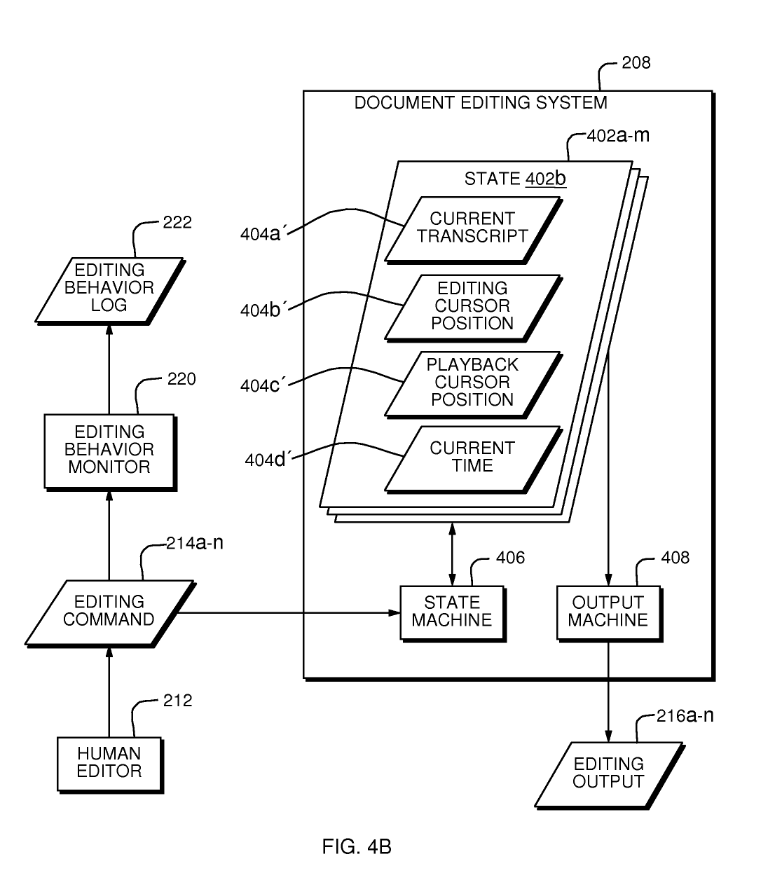

Referring to FIG. 4A, a dataflow diagram is shown which illustrates the editing process in more detail. As shown in FIG. 4A, the document editing system 208 includes states 402a-m, where m is the number of states 402a-m. State 402a is an initial state of the document editing system 208. Reference numeral 402 is used generally herein to refer to the states 402a-m collectively, while reference numerals such as 402a and 402b are used to refer to individual ones of the states 402a-m.

In the particular example illustrated in FIG. 4A, the initial state 402a of the document editing system 208 includes a current version 404a of the draft document 206 being edited by the document editing system 208. The current version 404a reflects any changes that the human editor 212 has made to the draft document 206 so far using the editing commands 214. In other words, the current version 404a is a version of the document that is intermediate between the draft document 206 and the edited document 210 shown in FIG. 2. When the editor 212 finishes the editing process, the current document 404a is provided as the edited document 210.

In the example illustrated in FIG. 4A, the initial state 402a of the document editing system 208 also includes an editing cursor position 404b, indicating the position within the current document 404a at which the document editing system 208 will apply the next editing command (such as adding or deleting a character). Like a conventional text editor or word processor, the document editing system 208 may display the editing cursor position 404b onscreen using a caret, underscore, or other visual marker within the text of the current document 404a.

If the spoken audio stream 202 is a recorded spoken audio stream, or if a recording of the spoken audio stream 202 is available to the document editing system 208, the document editing system 208 may play back such a recording to the human editor 212 to assist in the editing process. In such a case, the state 402a of the document editing system 208 may include a playback cursor position 404c, indicating the position within the spoken audio stream 202 that is currently being played back to the human editor 212. The playback cursor position 404c may, for example, be represented in units of time (such as milliseconds) or in units of data (such as bytes).

The state 402a of the document editing system 208 may, for example, include a current time 404d. The current time 404d may, for example, indicate the current date and time of day to the nearest millisecond. Alternatively, for example, the current time 404d may indicate the amount of time that has passed since the current editing session began, optionally excluding pauses.

Referring again to FIG. 3, the document editing system 208 may edit the draft document 206 to produce the edited document 210 as follows. The human editor 212 provides a first editing command 214a (step 306), which is received by a state machine 406 in the document editing system 208 (step 308). The editing command 214a may, for example, be a command to insert a character typed by the human editor 212, a command to delete the character at the editing cursor position 404b, or a command to navigate within the current document 404a (such as by moving one character left, right, up, or down).

In response to receiving the first editing command 214a, the state machine 406 modifies the initial state 402a of the document editing system 208 based on the editing command 214a (step 310), thereby producing a second state 402b, as shown in FIG. 4B. For purposes of example, all of the state information 404a-d in FIG. 4A is shown as being updated to produce updated state information 404a′, 404b′, 404c′, and 404d′ in FIG. 4B.

The nature of the state change made by the state machine 406 depends on the nature of the editing command 214a. For example, if the editing command 214a is a command to insert a particular character, the state machine 406 may modify the initial state 402a by inserting the specified character into the current document 404a at the current editing cursor position 404b. If the command 214a resulted from the human editor 212 hitting the left-arrow key, then the state machine 406 may modify the state 402a by decrementing the value of the editing cursor position 404b. If the command 214a is a command to rewind the playback of the spoken audio stream 202, then the state machine 406 may modify the state 402a by moving the playback cursor position 404c backwards in time.

These are merely examples of ways in which the state machine 406 may modify the initial state 402a in response to the editing commands 214 issued by the human editor 212. Certain aspects of the state 402, such as the current time 404d, may be configured not to be modifiable by the human editor 212. Furthermore, the state machine 406 may update certain aspects of the state 402 independently of the editing commands 214a issued by the human editor 212. For example, the state machine 406 may automatically and periodically update the current time 404d based on a system clock independently of the editing commands 214 issued by the human editor 212.

The document editing system 208 includes an output module 408, which renders the updated state 202b to the human editor 212 in the form of editing output 216a (step 310). The editing output 216a may, for example, display the updated version of the current document 404a′, reflecting changes made to it by the human editor 212. The editing output 216a may, for example, display the editing cursor at its updated position 404b′. The updated playback cursor position 404c′ may be rendered to the human editor 212 by, for example, highlighting text in the draft document 206 corresponding to the portion of the spoken audio stream 202 located at the new playback cursor position 404c′. These are merely examples of ways in which the updated state 402b of the document editing system 208 may be rendered to the human editor 212.

Steps 308-312 may be repeated any number of times to continue modifying the state 402 of the document editing system 208 (including the contents of the current document 404a), thereby producing additional updated states 402c-m and additional outputs 216b-m. The document editing process terminates after the document editing system 208 processes the final one of the editing commands 214, such as when the editor 212 saves and closes the current document 404a, at which point the current document 404a becomes the final edited document 210.

Aspects of the editing process may be monitored and logged (recorded) for subsequent analysis. For example, the system 200 of FIG. 2 includes an editing behavior monitor 220. The editing behavior monitor 220 may, for example, observe (monitor) and record (log) each of the editing commands 214a-n in an editing behavior log 222. For example, as shown in FIG. 3, when the human editor 212 issues the editing command 214a (step 304), the editing behavior monitor 220 receives the editing command 214a (step 320) and records the editing command 214a in the editing behavior log 222 (step 322). Steps 320 and 322 may, for example, be performed in parallel with, or serially with, steps 308-312. The editing behavior monitor 220 may record each of the editing commands 214 in the editing behavior log 222 in the sequence in which they are issued by the human editor 212.

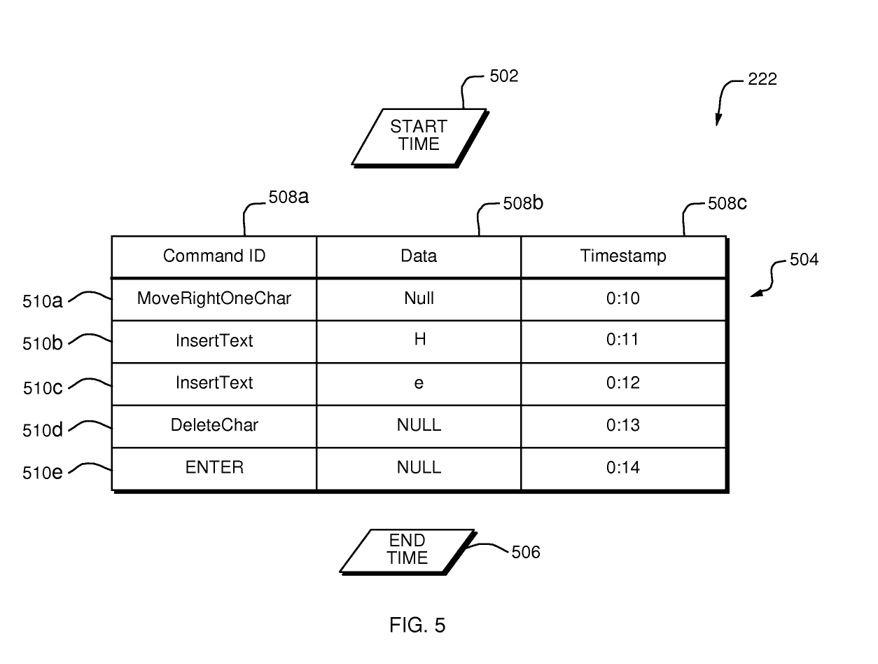

The editing behavior monitor 220 may store any of a variety of information in the editing behavior log 222. For example, referring to FIG. 5, a diagram is shown of the contents of the editing behavior log 222 according to one embodiment of the present invention. In FIG. 5, the editing behavior log 222 is illustrated as including an edit start time 502, an edit end time 506, and a table 504 of editing behaviors. The editing behavior monitor 220 stores a time representing the beginning of the editing session in the start time 502 and a time representing the ending of the editing session in the end time 506. The editing behavior monitor 220 may, for example, update the start time 502 when the draft document 206 is first presented to the editor 212 for editing, and update the end time 506 upon completion of the method 300 of FIG. 3.

The editing behavior table 504 includes three columns 508a-c and five rows 510a-e. Each of the rows 510a-e stores data corresponding to one of the monitored editing commands 214. Column 508a of each row stores a command identifier (command ID) of the command for which data are stored in the row. Column 508b of each row stores data, if any, monitored in conjunction with the command. Finally, column 508c of each row stores a timestamp indicating the time at which the corresponding editing command was monitored.

For example, the record in row 510a indicates that the human editor 212 inputted the command “MoveRightOneChar” (column 508a) when the current time 404d was equal to 0 minutes, 10 seconds (column 508c). Column 508b of row 510a contains NULL because no data are associated with a “MoveRightOneChar” command.

The record in row 510b indicates that the human editor 212 inputted the command “InsertText” (column 508a) having a data value of “H” when the current time 404d was equal to 0 minutes, 11 seconds (column 508c). This indicates a command to insert the single character “H” at the current editing cursor position 404b. Similarly, the record in row 510c indicates that the human editor 212 inputted the command “InsertText” (column 508a) having a data value of “e” when the current time 404d was equal to 0 minutes, 12 seconds (column 508c). This indicates a command to insert the single character “e” at the current editing cursor position 404b.

The record in row 510d indicates that the human editor 212 inputted the command “DeleteChar” (column 508a) having a data value of NULL when the current time 404d was equal to 0 minutes, 13 seconds (column 508c). This indicates a command to delete a single character at the current editing cursor position 404b. Finally, the record in row 510e indicates that the human editor 212 inputted the command “ENTER” (column 508a) having a data value of NULL when the current time 404d was equal to 0 minutes, 14 seconds (column 508c). This indicates a command to insert a paragraph break at the current editing cursor position 404b.

Note that the particular columns shown in FIG. 5 are shown merely for purposes of example and do not constitute limitations of the present invention. For example, columns shown in FIG. 5 may be omitted, and additional columns not shown in FIG. 5 may be added to the editing behavior log 222. For example, the log 222 may record the identity of the human editor 212 who issued each of the editing commands 214, the identity of the speaker of the audio stream 202, and/or the version of the document editing system 208 that was used to make the edits. More generally, the editing behavior log 222 may record all of any subset of the state 402 of the document editing system 208 at the time each of the editing commands 214 was issued.

Furthermore, the editing behavior log 222 is not limited to storing information about the editing commands 214, and is not limited to storing state information only at those times when editing commands 214 are issued. Rather, the editing behavior monitor 220 may, for example, periodically (e.g., once every second) record some or all of the state information 402 in the editing behavior log 222, whether or not the human editor 212 issues an editing command. Furthermore, one or more of the records in the editing behavior log 222 may lack information about any editing commands issued by the human editor 212. For example, a record in the editing behavior log 222 may record the editing cursor position 404b or the contents of the current document 404a, without recording information about any of the editing commands 214 issued by the human editor 212.

Although in the embodiment illustrated in FIG. 5 each of the commands 214 is recorded by reference to a command identifier (column 508a) and associated data (column 508b), this is merely one example of a way in which the commands 214 may be logged. As another example, the commands 214 may be logged by recording an indication of the physical inputs, such as mouse clicks, keystrokes, or foot pedal movements, that resulted in issuance of the commands 214.

Although the editing behavior log 222 is illustrated in FIG. 2 as a distinct element from the system 200, the log 222 may, for example, be combined with other elements of the system 200. For example, the log 222 may be stored within the edited document 210 itself. The editing behavior monitor 220 may generate multiple editing behavior logs, such as in the case in which a document is edited multiple times, potentially by different people. In such a case, the edited document 210 may include multiple editing behavior logs.

The editing behavior monitor 220 may “monitor” or “observe” the editing commands 214 in any of a variety of ways. For example, the document editing system 208 may provide an application program interface (API) which makes information about the commands 214 and the state 402 of the document editing system 208 accessible to external software applications. In such a case, the editing behavior monitor 220 may be implemented as a software application that is external to the document editing system 208 and which obtains information about the editing commands 214 through the API. The editing behavior monitor 220 may then record the information obtained through the API in the editing behavior log 222.

As another example, the document editing system 208 and the editing behavior monitor 220 may be implemented as a single software application or as an integrated software application suite. The editing behavior monitor 220 and the document editing system 208 may, for example, share source code and/or include executable modules which are linked to each other. As a result, the editing behavior monitor 220 may have access to information about the editing commands 214 and information about the state 402 of the document editing system 208 without the need to use an API.

The editing behavior monitor 220 may monitor all of the editing commands 214 or any subset thereof. Similarly, the editing behavior monitor 220 may monitor the state 402 of the document editing system 208 after each transition of that state 402, or any subset thereof. In one embodiment of the present invention, the editing behavior monitor 220 monitors all of the editing commands 214 issued by the human editor 212, including timestamps indicating the times at which all of the editing commands 214 were issued. Each such timestamp may reflect the value of the current time 404d at the time the timestamp is recorded. As will be explained in more detail below, maintaining such a comprehensive time-stamped log of the editing commands 214 enables real-time “playback” of the editing commands 214 and facilitates evaluating the editing behavior of the human editor 212 for purposes of improving the human editor's productivity.

The editing behavior monitor 220 may be configurable to log the editing commands 214 at different levels of detail, thereby providing flexibility in the amount of information that is logged per document. For example, the editing behavior monitor 220 may be capable of being configured to: (1) log nothing; (2) log the editing commands 214 and state information 402; or (3) log the editing commands 214, state information 402, and any differences produced in the current document 404a by each of the editing commands 214.

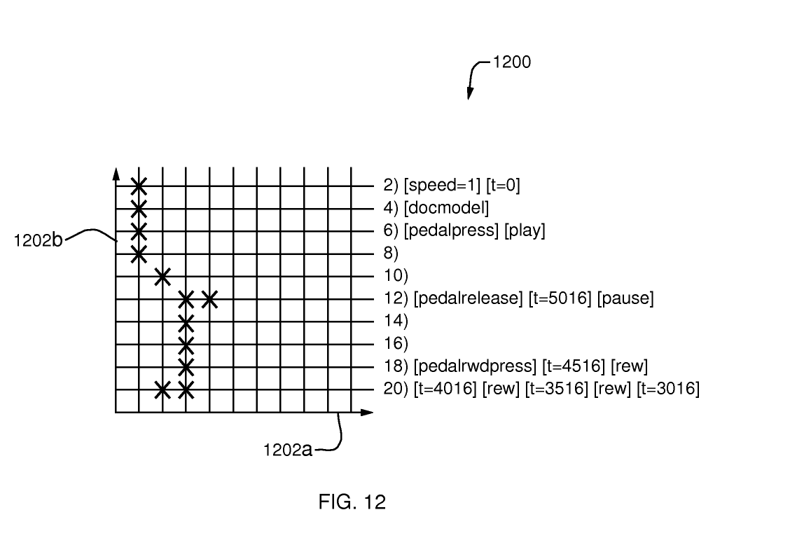

The system 200 may include means for displaying the editing behavior log 222 in any of a variety of ways. For example, the system 200 may display the editing behavior log 222 as a textual list of editing commands 214 and corresponding state information 402. Alternatively, for example, the system 200 may display the editing behavior log 222 as a two-dimensional graph, such as the graph 1200 shown in FIG. 12, in which the x axis 1202a represents the playback cursor position and the y axis 1202b represents the (absolute or relative) current time. In the example of FIG. 12, logged events (such as keys pressed, pedals depressed and released) are illustrated using cross marks at the coordinates corresponding the to the combination of playback time and edit time at which such events occurred. Events which occurred during the same 2-second interval are display at the same y coordinate on the graph 1200 of FIG. 12 for ease of illustration. Such a graph 1200 may provide the user with a more easily understandable representation of the editing behavior log 222 than a purely textual representation.

The human editor's editing behavior may be analyzed to produce statistics related to the editor's usage of features of the editing system 208. These statistics may be used to assess the editor's productivity and to produce recommendations both for improving the editor's productivity and for improving the editing system 208 itself.

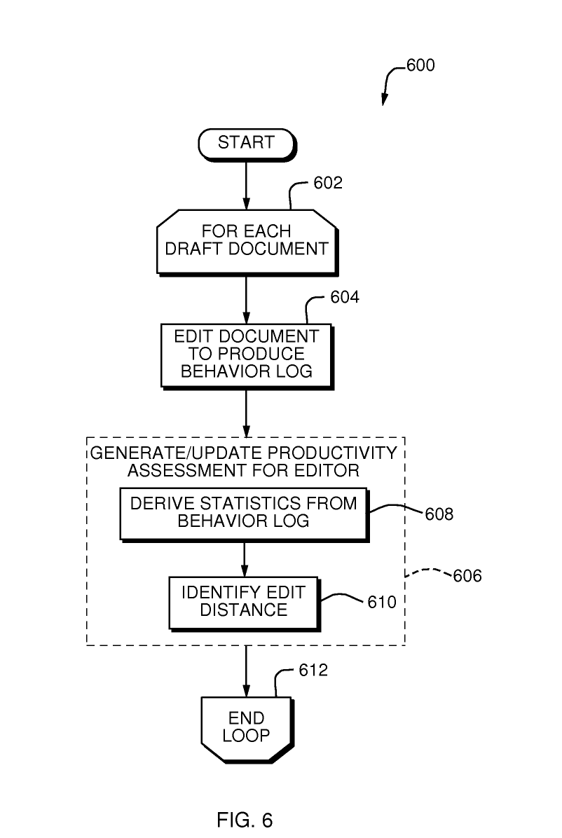

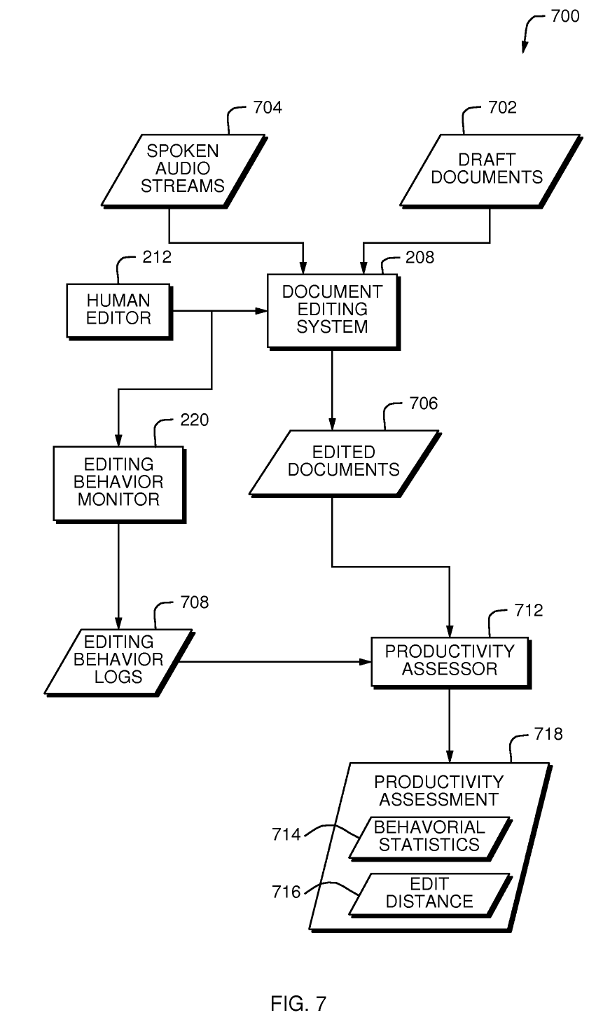

For example, referring to FIG. 6, a flowchart is shown of a method 600 for developing a productivity assessment of the editor 212 according to one embodiment of the present invention. Referring to FIG. 7, a dataflow diagram is shown of a system 700 for performing the method 600 of FIG. 6 according to one embodiment of the present invention.

In general, in the embodiment shown in FIGS. 6 and 7, multiple draft documents 702 correspond to multiple spoken audio streams 704. The editor 212 uses the document editing system 208 to edit the draft documents 702 and thereby to produce edited documents 706 with corresponding editing behavior logs 708.

More specifically, referring to FIG. 6, for each of the draft documents 702 (step 602), editor 212 uses the editing system 208 to edit the draft document and thereby produce a corresponding one of the edited transcripts 706 and behavior logs 708 (step 604).

A productivity assessor 712 produces a productivity assessment 718 of the editor 212 based on the current editing behavior log, draft document, and edited document (step 606). The productivity assessor 712 may, for example, derive behavioral statistics 714 from the current one of the behavior logs 708 and include the behavioral statistics 714 in the productivity assessment 718 (step 608).

The behavioral statistics 714 may, for example, include both “core” statistics and higher-level statistics derived from the core statistics. Core statistics are those produced from direct measurement of the editor's editing behavior during an editing session, such as the number of times a certain keyboard shortcut was pressed during the editing session. An example of a higher-level statistic that may be derived from one or more core statistics is the percentage of the audio stream that the editor played back exactly three times. Another example of a higher-level statistic is editing efficiency, which may be measured as the amount of time it took the editor to edit the draft document (e.g., the difference between the editing start time and end time) divided by the length of the corresponding spoken audio stream.

Core statistics relate to a particular editing session. Higher-level statistics, however, may be derived from multiple editing sessions. As a result, initial values for higher-level statistics may be derived from one or more editing sessions. Those initial values may be refined over time as more editing behavior data become available from more editing sessions.

The productivity assessor 712 may derive any number of levels of statistics from the core statistics. For example, the productivity assessor 712 may derive a first set of higher-level statistics from the core statistics, and then derive a second set of higher-level statistics from the first set, without relying directly on the core statistics.

Other examples of behavioral statistics 714, including both core and derived statistics, include but are not limited to: number and duration of periods of inactivity (i.e., periods during which the human editor 212 provides no input to the document editing system 208); minimum, maximum, mean, and standard deviation of the audio playback speed during the editing session; percentage of editing operations performed during the editing session; percentage of the spoken audio stream played at least once, twice, thrice, etc.; frequency of mouse-clicks; frequency of use of particular editing cursor positioning keys and/or keyboard shortcuts; frequency of use of particular audio cursor positioning keys, keyboard shortcut, and/or footpedal operations; frequency of use of keyboard shortcuts for toggling lists, sections, and bookmarks on and off; and whether the spell-checking feature was used.

Frequencies of use may be measured in any of a variety of ways, such as: (1) binary indicators (“used” or “not used”); (2) absolute values (“used x number of times”); or (3) relative values (“used x % of the time”).

The productivity assessor 712 may also develop, and include in the productivity assessment 718, an edit distance 716 indicating the degree of difference between the current draft document and corresponding edited document (step 610). If the draft documents 702 and edited documents 706 were not recorded in the editing behavior logs 708, then the draft documents 702 and edited documents 706 may be provided as inputs directly to the productivity assessor 712 for use in computing the edit distance 716.

The productivity assessment 718 for the editor 212 may be augmented by repeating steps 604-610 for additional documents edited by the same editor 212 (step 612). The additional data provided by such additional editing sessions may be used to refine the behavioral statistics 714, which as a result may represent aggregate behavioral statistics across all of the editing sessions. Similarly, the edit distance 716 may represent an aggregate (e.g., average) edit distance 716 across all of the editing sessions.

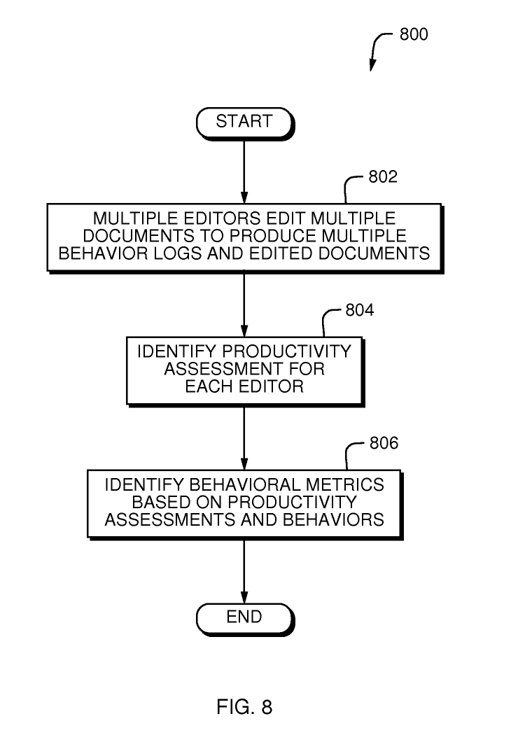

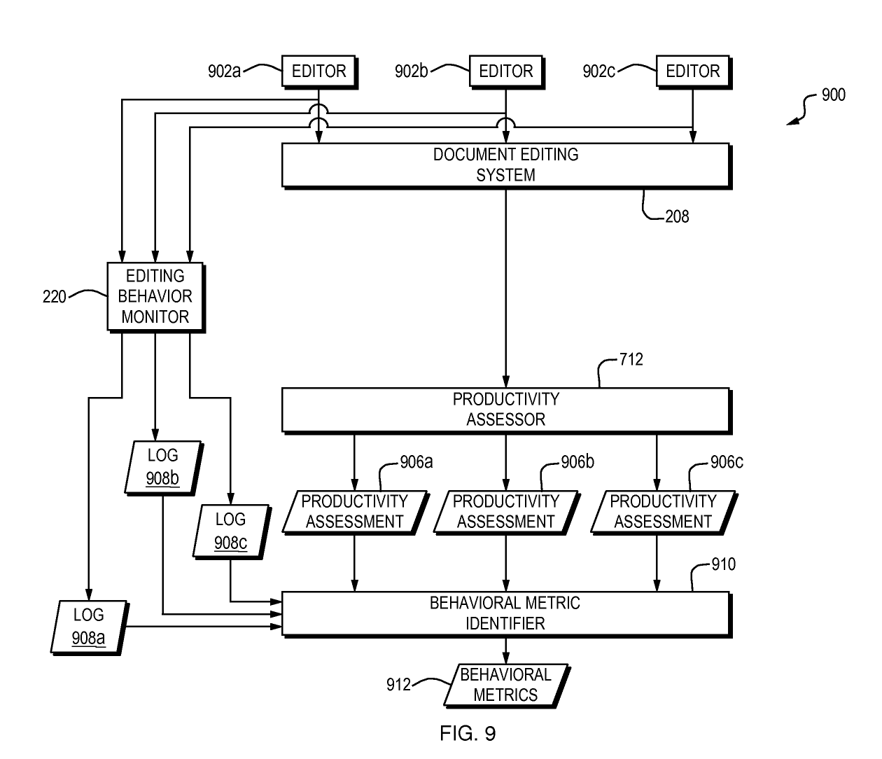

Referring to FIG. 8, a flowchart is shown of a method for developing productivity assessments for multiple editors and then correlating those assessments with editing behaviors to identify the extent to which different editing behaviors contribute to or detract from productivity. Referring to FIG. 9, a dataflow diagram is shown of a system 900 for performing the method 800 of FIG. 8.

Each of a plurality of human editors 902a-c uses the document editing system 208 to edit a plurality of documents (not shown) and thereby to produce a plurality of edited documents (now shown) and editing behavior logs 908a-c using the techniques disclosed above (step 802). The productivity assessor 712 produces productivity assessments 906a-c of the editors 902a-c, respectively, using the techniques disclosed above (step 804).

A behavioral metric identifier 910 produces a set of behavioral metrics 912 based on the productivity assessments and the behavior logs 908a-c (step 806). A “behavioral metric” may, for example, be a measure of the correlation between a particular editing behavior and productivity. For example, one behavioral metric may indicate whether frequent use of a “move right one word” command contributes positively to productivity, while another behavioral metric may indicate whether frequent use of a “delete entire word” command contributes positively to productivity. Behavioral metrics may, for example, be binary (i.e., indicate whether or not a behavior contributes to productivity), be measured on a linear scale (e.g., a scale of −5 through +5, where −5 indicates a significant negative effect on productivity, zero indicates no effect on productivity, and +5 indicates a significant positive effect on productivity), or be represented in other ways.

The behavioral metrics 912 may indicate not only the extent of correlation between use/nonuse of a particular editing behavior and productivity, but also the extent to which other characteristics of use of that behavior contribute to productivity. For example, a particular metric may indicate the extent to which using a particular behavior with a particular frequency contributes to productivity. As a result, there may be multiple metrics for the same editing behavior, each of which indicates a degree of correlation between that behavior and productivity under different circumstances.

The behavioral metrics 912 produced by the behavioral metric identifier 910 may, for example, include a behavioral metric for every behavior allowed by the document editing system 208 or for any subset thereof (such as the subset observed in the editing logs 908a-c processed by the behavioral metric identifier 910). In general, the behavioral metric identifier 910 may produce the behavioral metrics 912 by identifying statistical correlations between the editing behaviors of the editors 902a-c (as recorded in the editing logs 908a-c) with the corresponding productivity assessments 906a-c. In general, for example, if the use of a particular editing behavior (such as moving the editing cursor to the right by entire words rather than by individual characters) is found to have a strong correlation with high editing efficiency, then the behavioral metric for the behavior of moving the editing cursor to the right by an entire word may have a high value (e.g., +5 on a scale of −5 to +5).

Any of a variety of well-known statistical techniques may be used to perform such correlations and thereby to produce the behavioral metrics 912. Furthermore, alternatively the behavioral metrics 912 may be entirely or partially predetermined rather than produced based on statistical analysis of the behavior logs 908a-c and productivity assessments 906a-c. For example, the behavioral metrics 912 may be initialized to predetermined values based on predictions of correlations between editing behaviors and productivity, which may be updated or replaced by the results of statistical analysis as more data are gathered.

For example, one behavioral metric may be initialized to indicate that repeated use of the DELETE key to delete all characters in a word individually has a strong negative effect on productivity, while another behavioral metric may be initialized to indicate that repeated use of the DELETE key to delete a single character has a strong positive effect on productivity. Such initial values, however, may be modified or replaced based on observed correlations between use of the DELETE key and productivity.

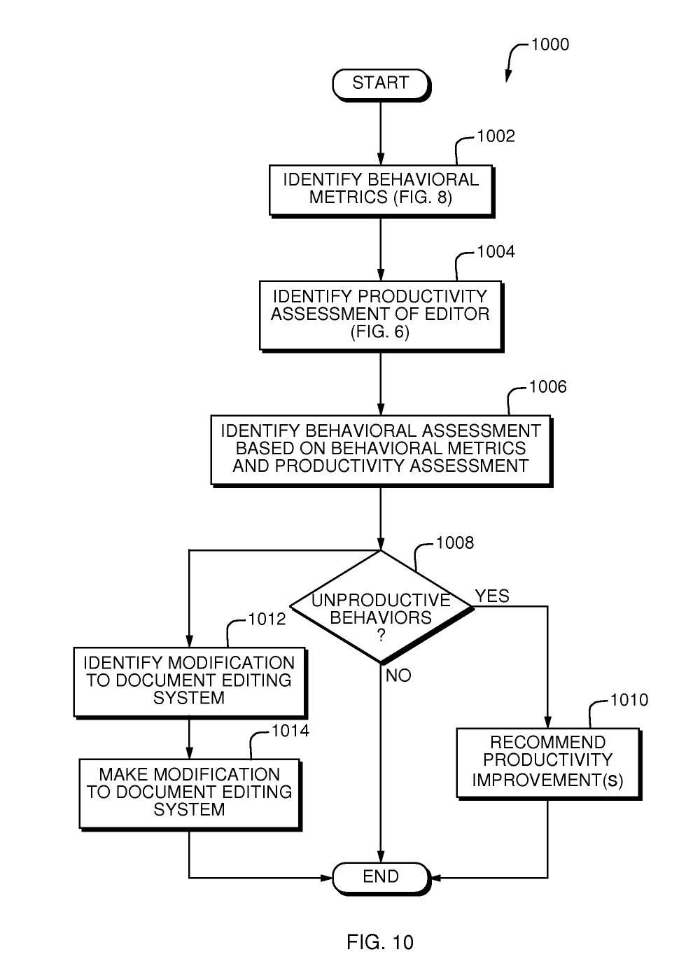

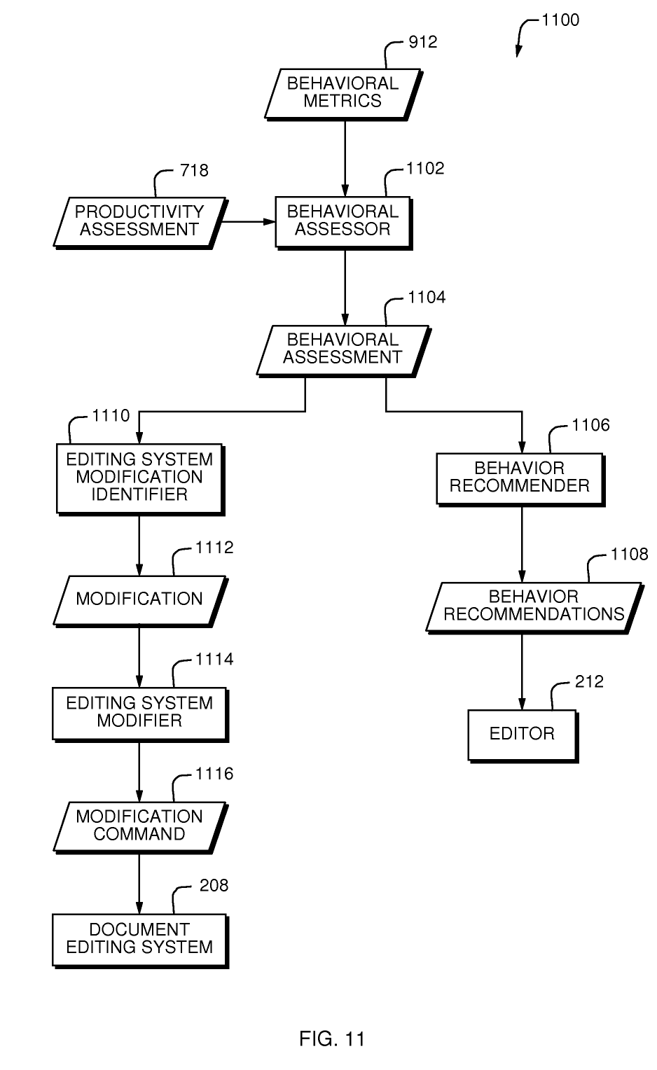

The behavioral metrics 912 may be used to evaluate the productivity of the editor 212 and to develop recommendations for improving the editor's productivity. Referring to FIG. 10, for example, a flowchart is shown of a method 1000 for producing a behavioral assessment of the editor 212 based on the behavioral metrics 912 according to one embodiment of the present invention. Referring to FIG. 11, a dataflow diagram 1100 is shown of a system 1100 for performing the method 1000 of FIG. 10 according to one embodiment of the present invention.

The method 1000 identifies the behavioral metrics 912 using the techniques disclosed above with respect to FIGS. 8 and 9 (step 1002). The method 1100 identifies the productivity assessment 718 of the editor 212 using the techniques disclosed above with respect to FIGS. 6 and 7 (step 1104). A behavioral assessor 1102 develops a behavioral assessment 1104 of the editor 212 based on the behavioral metrics 912 and the productivity assessment 718 (step 1104).

In general, the behavioral assessment 1104 may indicate whether, and the extent to which, the observed editing behaviors of the editor 212 (as indicated, for example in the editor's behavior logs 708) are correlated with productivity. The behavioral assessor 1102 may develop the behavioral assessment 1104 by, for example, comparing statistics related to the usage by the particular editor 212 of particular features of the editing system 208 (such as particular commands) with the corresponding behavioral metrics 912. If, for example, the behavioral metrics 912 indicate that frequent use of a particular command correlates strongly with high productivity, and the productivity assessment 718 of the editor 212 indicates that the editor 212 uses that command frequently, then the behavioral assessment 1104 may indicate a high score for the editor's use of that command. Similarly, if the behavioral metrics 912 indicate that infrequent use of a particular command correlates strongly with high productivity, and the productivity assessment 718 indicates that the editor 212 uses that command frequently, then the behavioral assessment 1104 may indicate a low score for the editor's use of that command. In this way, the knowledge gained from large numbers of editing sessions by multiple editors may be used to gauge the productivity of the particular editor 212 (and of other particular editors).

The behavioral assessment 1104 may assess the editor's behavior at any level of granularity. For example, the behavioral assessment 1104 may include a distinct assessment for each editing behavior performed by the editor 212. Alternatively, for example, the behavioral assessment 1104 may include an aggregate value representing a single “productivity score” for the editor 212. Such an aggregate value may, for example, be derived from individual behavioral assessments for different behaviors performed by the editor 212, such as particular behaviors which have been determined to contribute significantly to high productivity. These are merely examples of forms that the behavioral assessment 1104 may take.

The behavioral assessment 1104 may be used to develop recommendations for improving the productivity of the human editor 212. For example, the system 1100 may include a behavior recommender 1106 which determines whether the behavioral assessment 1104 indicates that the editor 212 has engaged in any unproductive editing behaviors (step 1008). This determination may be made, for example, by determining whether the editor's frequency of use of a particular editing behavior falls below a particular threshold. Such a threshold may be identified, for example, relative to the editing behaviors of other editors. For example, an editing behavior of the editor 212 may be determined to be “unproductive” if that behavior has a negative correlation with overall productivity and is engaged in by editors having overall productivities in the bottom 10% among all editors, but not by editors having overall productivities in the top 10% among all editors. These are merely examples of ways in which the editing behavior of the editor 212 may be determined to be “unproductive.”

If the behavior recommender 1106 determines that the editor 212 has engaged in one or more unproductive behaviors, then the behavior recommender 1106 provides one or more behavior recommendations 1108 to the editor 212 (step 1010). The recommendations 1108 may be developed in any of a variety of ways and recommend that the editor 212 take any of a variety of actions.

The recommendations 1108 may, for example, recommend editing behavior that the editor 212 could apply in the future to improve his or her editing productivity. In general, if the editor's behavioral assessment 1104 indicates that the editor 212 makes frequent use of a particular low-productivity feature, the recommender 1006 may recommend that the editor 212 use that feature less frequently. Similarly, if the behavioral assessment 1104 indicates that the editor 212 makes infrequent use of a particular high-productivity feature, the recommender 1106 may recommend that the editor 212 use that feature more frequently.

For example, if the behavioral assessment 1104 indicates that the human editor 212 frequently deletes words by repeatedly pressing the DELETE key for each character to be deleted, the behavior recommender 1106 may recommend the use of the CTRL-DELETE key combination to delete entire words more efficiently.

As another example, a minimum and/or maximum value may be associated with each of the behavioral statistics 714 (FIG. 7). If the value of a particular statistic for editor 212 is below its associated minimum value, the recommendations 1108 may recommend that the editor 212 engage in a behavior intended to increase the value of the corresponding statistic. For example, if the editor's average playback speed falls below a specified minimum value, then the recommendations 1108 may recommend that the editor 212 increase the average playback speed. Similarly, if the value of a particular statistic for editor 212 is higher than its associated maximum value, the recommendations 1108 may recommend that the editor 212 engage in a behavior intended to decrease the corresponding statistic.

Another example of a behavioral statistic is the ratio of the number of keystrokes made while the audio stream 202 was playing to the number of keystrokes made while the audio stream 202 was paused. Higher values of this ratio indicate more efficient editing behavior, because it indicates that the editor 212 was typing while listening to the audio stream 202, thereby multitasking. If this ratio is low, the behavior recommender 1106 may recommend that the editor 212 pause the audio stream 202 less frequently.

The document editing system 208 may include a feature allowing the editor 212 to move the text cursor to the text corresponding to the portion of the audio stream 202 currently being played. Similarly, the document editing system 208 may include a feature allowing the editor 212 to move the playback cursor to the portion of the audio stream 202 corresponding to the text at the current text cursor position. Such features may be activated, for example, using preconfigured keyboard shortcuts. Using such features can significantly increase editing efficiency compared to using conventional rewind and fast forward functions (such as those activated by a foot pedal). For example, moving the playback cursor to the portion of the audio stream 202 corresponding to the current text cursor position allows the editor to instantly rewind or fast forward the audio stream 202 to precisely the location of the text currently being edited, without the risk of overshooting the mark. Use of these features may therefore be treated as indicators of high productivity. If the editor 212 fails to use these features, the behavior recommender 1106 may recommend that the editor 212 make use of them in the future.

Examples of other editing behaviors that the productivity assessor 712 may treat as indicators of high productivity include relatively infrequent replaying of portions of the audio stream 202, speeding up playback of the audio stream 202, using navigational keyboard shortcuts for performing functions such as moving forward and backward by entire words and for moving to the beginning and end of a document t, and using editing keyboard shortcuts for performing functions such as cutting, copying, and pasting text. Failure to use, or insufficiently frequent use of, these features may cause the behavior recommender 1106 to recommend that the editor 212 use those features more frequently.

The productivity assessor 712, when producing the productivity assessment 718 of the editor, may also take into account (using the timestamps 508c) the time(s) at which the editor 212 engaged in certain editing behaviors. For example, the productivity assessor 712 may treat the editing behavior of speeding up the audio playback speed near the beginning of audio playback as having a greater contribution to productivity than speeding up the audio playback speed near the end of audio playback.

The recommendations 1108 may take any of a variety of forms, such as a report describing the recommended behavior(s), a popup window describing the recommended behavior(s), or an onscreen animation displaying the keystrokes and/or other actions required to perform the recommended behavior(s). The recommendations 1108 may include the editor's productivity assessment 718 and/or behavioral assessment 1104, which may also be presented to the editor 212 in any of a variety of forms.

The recommendations 1108 may be provided on a variety of schedules, such as on-demand, once every day/week/month, or according to any other schedule. Second and subsequent sets of recommendations 1108, which may include the productivity assessment 718 and/or behavioral assessment 1104, may include comparisons to previous assessments and recommendations for the editor 212, providing information such as whether the editor's use of a particular behavior has increased or decreased since the last assessment, or whether the editor's overall degree of productivity has increased or decreased since the last assessment.

The techniques disclosed in FIGS. 10 and 11 may be used to develop behavioral assessments for multiple editors. Such assessments may be used to rank the editor 212 relative to other editors, by comparing the behavioral assessment 1104 of the editor 212 to the behavioral assessments of the other editors, and thereby to identify over- and under-achievers. For example, the editor 212 may be classified as an under-achiever if the editor's overall behavioral assessment score is in the bottom 10% of all behavioral assessment scores and be classified as an over-achiever if the editor's overall behavioral assessment score is in the top 10% of all behavioral assessment scores.

The behavioral assessment 1104 may also be used to improve the document editing system 208 itself. For example, referring again to FIGS. 10 and 11, the system 1100 may also include an editing system modification identifier 1110, which identifies a modification 1112 to the document editing system 208 to improve the productivity of the human editor 212 when using the document editing system 208 (step 1012). For example, if the human editor 212 frequently increased the playback speed of the spoken audio stream 202 by 20% when editing the draft document 206, the editing system modification identifier 724 may recommend that the default playback speed of the document editing system 208 be increased by 20%.

As another example, the behavioral assessment 1104 may be used to determine whether an existing or newly-added editing feature is correlated with editing efficiency. If, for example, a certain editing feature is determined not to be correlated with editing efficiency for any human editor, it can be concluded that the feature is either not being used as intended, or that the feature is not effective at improving editing efficiency. This process may be used to evaluate whether new or proposed new editing features actually are effective at improving editing efficiency. As a result, proposed new features may be tested by, for example, deploying them in a limited user study and measuring their actual effectiveness at improving editing efficiency before actually deploying them in the field.

The system 1100 further includes an editing system modifier 1114, which makes the recommended modification 1112 to the document editing system 208 by providing a modification command 1116 to the document editing system 208 (step 1014). Note that the modification 1112 need not be applied in all contexts. For example, the modification 1112 may be recorded in a user profile associated with the particular human editor 212, so that the modification 1112 (and any other modifications resulting from the productivity assessment 718 of the human editor 212) is applied to the document editing system 208 only when that particular human editor 212 uses the document editing system 208. Modifications made based on productivity assessments of other human editors (not shown) may similarly be stored in those editors' profiles and applied when those editors use the document editing system 208, thereby enabling the document editing system 208 to be tailored to the behavior of each of the editors.

It was mentioned earlier that the productivity assessor 712 may develop the productivity assessment 718 by “playing back” the editing commands 214 originally issued by the human editor 212. Such playback may be performed by providing the original draft document 206 to the document editing system 208 and issuing the editing commands 214, as recorded in the editing behavior log 222, to the document editing system 208 at the time intervals recorded in the editing behavior log 222. By issuing each of the commands to the editing system 208 in the sequence and at the times they were originally provided by the editor 212, the editor's behavior may be reconstructed and thereby “played back.”

Such playback may be useful to perform, for example, if the editor's productivity is low but the cause(s) cannot be identified easily based solely on the editing log 222. In this case, the editor's behavior may be played back and observed by a trained technician in an attempt to identify the cause(s) of the editor's low productivity.

Embodiments of the present invention have a variety of advantages. For example, in general, embodiments of the present invention may be used to improve the editing efficiency of medical language specialists and others tasked with editing draft documents produced using automatic speech recognizers and other means. In particular, ways in which the human editor 212 is making unproductive use of the document editing system 208 may be identified. In response, the system may recommend ways for the editor to make more productive use of the system. Furthermore, the system may modify itself, such as by increasing the default playback speed, based on the observed behavior of the human editor and thereby fine-tune the system for more productive use by the editor in the future.

Techniques disclosed herein are useful even when specific recommendations are not provided to the editor 212. For example, the productivity assessment 718 of the editor 212 may be presented as targeted feedback to the editor 212, in response to which the editor 212 may draw his or her own conclusions about how to increase productivity. Similarly, the productivity assessments of multiple editors may be compared to each other to identify particularly efficient or inefficient behaviors common to the editors, thereby enabling productivity problems to be prioritized accurately.

Monitoring and logging all user interactions (such as keystrokes, mouse clicks, and footpedal operations) has a variety of benefits. For example, because such comprehensive, time-stamped logging captures all relevant aspects of the editing behavior, it enables the editing behavior analysis to be deferred, and potentially performed off-site. Multiple editing sessions performed at multiple sites at different times may be analyzed at one site in a batch, with aggregate statistics compiled. This may both reduce the cost and increase the speed, power, and flexibility of the productivity analysis that is performed.

The productivity assessments and other measures derived using the techniques disclosed herein may be used for a variety of purposes, such as productivity-based compensation schemes for editors and tracking of learning curves (i.e., improvement in productivity over time). Editors whose performance is below average and/or who do not improve sufficiently over time may be identified as warranting additional follow-up training.

More generally, the productivity assessments and other measures derived using the techniques disclosed herein may be used to assist in training editors, such as by identifying specific productivity features of the document editing system 208 which the editor 212 has not used correctly or with sufficient frequency. The same measures may be used to guide further development of the editing system 208, such as by providing insight into which additional productivity features should be added to future versions of the system 208.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The productivity assessment 718 provided by the productivity assessor 712 need not include a score or any other measure directly representing productivity of the human editor 212. For example, the editing behavior logs 708 themselves may play the role of the productivity assessment 718, in which case the behavioral metrics 912, behavioral assessment 1104, recommended editing behavior 718, and recommended editing system modification 726 may be identified based on the editing behavior logs 708, without generating a separate productivity assessment. Similarly, the behavioral assessment 1104 may be developed based directly on the productivity assessment 718 and/or behavior logs 708, without generating separate behavioral metrics 912.

Just as the functions performed by the productivity assessment 718 and the editing behavior log 222 may be combined, so too may they be separated into additional elements. For example, the productivity assessment 718 may include both conclusions (such as statistics) drawn from the editing behavior log 222 and one or more productivity scores derived from those conclusions.

Information derived from the behavior logs 708, such as the productivity assessment 718, behavioral metrics 912, and behavioral assessment 1104 may further be based on the identity of the editor 212. For example, the productivity assessor 712 may recommend certain behaviors only to editors having at least a predetermined minimum number of years of experience, having certain job titles, or having productivities falling below a predetermined threshold level.

Terms such as “edit,” “editing behavior,” and “editing commands” refer herein not only to actions which cause changes to be made to a document (such as adding, deleting, or moving text within the document), but also to actions for navigating within a document (such as moving the editing cursor within the document), and other actions performed by the human editor 212 when editing the document. In general, any input provided by the human editor 212 to the document editing system 208 is an example of “editing behavior” as that term is used herein. As such, editing behavior may include, for example, any mouse click, keystroke, or foot pedal movement, whether or not such input modifies the document being edited. Furthermore, “editing behavior” that may be monitored by the editing behavior monitor 220 and logged in the editing behavior log 222 includes not only actions taken by the human editor 212, but also inaction by the human editor 212. For example, lack of input by the human editor 212 (e.g., failure to respond to a prompt within a specified maximum period of time) may qualify as “editing behavior” that may be identified by the editing behavior monitor 220 and logged in the editing behavior log 222.

Furthermore, although the human editor 212 may edit the draft document 206 for the purpose of correcting errors in the draft document 206, editing may be performed for reasons other than correcting errors, such as supplementing information in the draft document 206 and modifying the format of the draft document 206 to comply with an applicable report format. Terms such as “edit” and “editing behavior,” therefore, are not limited herein to editing performed for the purpose of correcting errors.

The techniques disclosed herein may be used in conjunction with any document editing system. One example of such a document editing system is AnyModal Edit, available from MultiModal Technologies, Inc. of Pittsburgh, Pa. AnyModal Edit is an editing application specifically developed for efficient proof-reading of draft documents with corresponding dictation.

Although certain embodiments may be described herein in the context of clinical documentation, the present invention is not limited to use in that context. More generally, embodiments of the present invention may be applied to document transcription in any context, and even more generally to document editing in any context. For example, the techniques disclosed herein may be applied to editing documents which were not generated using an automatic speech recognizer and/or natural language processing technologies.

In certain embodiments disclosed herein, the audio stream 202 is played back. Playing back a recorded audio stream, such as through audio speakers, is one example of “presenting” a multimedia stream. Such a presentation may, for example, include any combination of audio, video, text, and images, and need not duplicate all features of the original recorded media stream. For example, the presentation may expand or contract the timescale of the media stream (i.e., slow it down or speed it up) according to any temporal profile, and/or reflect other processing that has been performed on the media stream.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method for use with a document editing system and a first plurality of documents, the method comprising:
(A) identifying first actual editing behavior applied by a user to the document editing system to edit the first plurality of documents;
(B) deriving a statistic from the first identified editing behavior; and
(C) identifying potential editing behavior, suitable for application by the user to the document editing system to edit the documents, based on the derived statistic.

2. The method of claim 1, further comprising:
(D) providing to the user an indication of the potential editing behavior.

3. The method of claim 1, wherein (A) comprises:
(A) (1) monitoring input provided by the user to the document editing system to edit the first plurality of documents; and
(A) (2) storing a record of the monitored input.

4. The method of claim 3, wherein (A) (1) comprises monitoring a plurality of inputs provided by the user and a plurality of associated input times, and wherein (A) (2) comprises storing a record of the plurality of inputs and the plurality of associated input times.

5. The method of claim 3, wherein (A) (2) comprises storing the record of the monitored input in at least one of the first plurality of documents.

6. The method of claim 5, further comprising:
(D) identifying second actual editing behavior applied by a second user to the document editing system to edit the at least one of the first plurality of documents; and
(E) storing a record of the second actual editing behavior in the at least one of the first plurality of documents.

7. The method of claim 1, wherein the value of the statistic indicates whether the first actual editing behavior includes use by the user of a particular feature of the document editing system.

8. The method of claim 1, wherein the value of the statistic indicates a frequency with which a particular feature of the document editing system is represented within the first actual editing behavior.

9. The method of claim 1, wherein the document editing system comprises means for playing an audio stream under control of the user, and wherein the value of the statistic indicates whether the user used the means for playing to play the entire audio stream.

10. The method of claim 1, wherein the document editing system comprises means for playing an audio stream under control of the user, and wherein the value of the statistic indicates an amount of the audio stream that the user played more than once using the means for playing.

11. The method of claim 1, wherein (A) comprises identifying first actual editing behavior applied by the user during an editing session of a particular duration, wherein the document editing system comprises means for playing an audio stream under control of the user, and wherein the value of the statistic indicates a relationship between the particular duration of the editing session and a total amount of time the audio stream was played back under control of the user.

12. The method of claim 1, further comprising:
(D) identifying a state of the document editing system; and
wherein (C) comprises identifying the potential editing behavior based on the first actual editing behavior and the state of the document editing system.

13. The method of claim 12, wherein (D) comprises identifying a current position of an editing cursor in the document editing system.

14. The method of claim 12, wherein (D) comprises identifying a position in a spoken audio stream corresponding to a current position of an editing cursor in the document editing system.

15. The method of claim 12, wherein (D) comprises identifying a current playback speed of the document editing system.

16. The method of claim 12, wherein (D) comprises identifying at least one of an author, a source, and an audio quality of at least one of the first plurality of documents.

17. The method of claim 1, wherein the first actual editing behavior comprises input to edit the first plurality of documents.

18. The method of claim 1, wherein the first actual editing behavior comprises input to navigate within the first plurality of documents.

19. The method of claim 1, wherein the first actual editing behavior comprises keyboard input.

20. The method of claim 1, wherein the first actual editing behavior comprises mouse input.

21. The method of claim 1, wherein the first actual editing behavior comprises foot pedal input.

22. The method of claim 1, wherein the document editing system comprises means for playing a spoken audio stream representing content in common with a document, and wherein the first actual editing behavior comprises an instruction to change a speed at which the document editing system plays the spoken audio stream.

23. The method of claim 1, further comprising:
(A) identifying an identity of the user; and
wherein (B) comprises identifying the potential editing behavior based on the first actual editing behavior and the identity of the user.

24. The method of claim 1, wherein (A) comprises identifying the first actual editing behavior applied by the user to the document editing system to edit an original version of one of the first plurality of documents and thereby to produce an edited document; and wherein (B) comprises identifying the potential editing behavior based on the first actual editing behavior and a difference between the original version of the document and the edited document.

25. The method of claim 1, wherein (A) comprises identifying a difference between a start time and an end time of the first actual editing behavior, and wherein (B) comprises identifying the potential editing behavior based on the first actual editing behavior and a difference between the start time and the end time.

26. The method of claim 1, further comprising:
(B) before (A), generating the first plurality of documents based on a plurality of spoken audio streams using an automatic document transcription system.

27. The method of claim 1, wherein (A) comprises:
(A) (1) monitoring typed input provided by at least one user to create the first plurality of documents.

28. The method of claim 1, wherein (B) comprises deriving a first plurality of statistics from the first actual editing behavior, and wherein the method further comprises:
(D) deriving a first aggregate score for the user from the first plurality of statistics; and
(E) providing the first aggregate score to the user.

29. The method of claim 28, further comprising:
(F) identifying second editing behavior applied by a user to the document editing system to edit a second plurality of documents;
(G) deriving a second aggregate score for the user from the second plurality of statistics; and
(H) providing the second aggregate score to the user.

30. The method of claim 29, further comprising:
(I) providing the user with an indication of a difference between the first aggregate score and the second aggregate score.

31. The method of claim 1, wherein (B) comprises:
(B) (1) deriving a core statistic from measurement of editing behavior of the user during a single editing session; and
(B) (2) deriving a higher-level statistic from the core statistic.

32. The method of claim 1, wherein (B) comprises:
(B) (1) deriving a first core statistic from measurement of first editing behavior of the user during a single editing session; and
(B) (2) deriving a second core statistic from measurement of second editing behavior of the user during the single editing session; and
(B) (3) deriving a higher-level statistic from the first and second core statistics.

33. The method of claim 1, further comprising:
(D) providing to the user a graphical display of the first actual editing behavior.

34. An apparatus for use with a document editing system and a first plurality of documents, the apparatus comprising:
actual editing behavior identification means for identifying first actual editing behavior applied by a user to the document editing system to edit the first plurality of documents;
statistic derivation means for deriving a statistic from the first identified editing behavior; and
potential editing behavior identification means for identifying potential editing behavior, suitable for application by the user to the document editing system to edit the documents, based on the derived statistic.

35. The apparatus of claim 34, further comprising:
means for providing to the user an indication of the potential editing behavior.

36. The apparatus of claim 34, wherein the actual editing behavior identification means comprises:
input monitoring means for monitoring input provided by the user to the document editing system to edit the first plurality of documents; and
record storing means for storing a record of the monitored input.

37. The apparatus of claim 36, wherein the record storing means comprises means for storing the record of the monitored input in at least one of the first plurality of documents.

38. The apparatus of claim 34, wherein the value of the statistic indicates whether the first actual editing behavior includes use by the user of a particular feature of the document editing system.

39. The apparatus of claim 34, wherein the value of the statistic indicates a frequency with which a particular feature of the document editing system is represented within the first actual editing behavior.

40. The apparatus of claim 34, wherein the document editing system comprises means for playing an audio stream under control of the user, and wherein the value of the statistic indicates whether the user used the means for playing to play the entire audio stream.

41. The apparatus of claim 34, wherein the document editing system comprises means for playing an audio stream under control of the user, and wherein the value of the statistic indicates an amount of the audio stream that the user played more than once using the means for playing.

42. The apparatus of claim 34, wherein (A) comprises identifying first actual editing behavior applied by the user during an editing session of a particular duration, wherein the document editing system comprises means for playing an audio stream under control of the user, and wherein the value of the statistic indicates a relationship between the particular duration of the editing session and a total amount of time the audio stream was played back under control of the user.

43. The apparatus of claim 34, further comprising:
means for identifying a state of the document editing system; and
wherein the potential editing behavior identification means comprises means for identifying the potential editing behavior based on the first actual editing behavior and the state of the document editing system.

44. The apparatus of claim 34, wherein the first actual editing behavior comprises input to edit the first plurality of documents.

45. The apparatus of claim 34, wherein the first actual editing behavior comprises input to navigate within the first plurality of documents.

46. The apparatus of claim 34, wherein the document editing system comprises means for playing a spoken audio stream representing content in common with a document, and wherein the first actual editing behavior comprises an instruction to change a speed at which the document editing system plays the spoken audio stream.

47. The apparatus of claim 34, further comprising:
means identifying an identity of the user; and
wherein the statistic derivation means comprises means for identifying the potential editing behavior based on the first actual editing behavior and the identity of the user.

48. The apparatus of claim 34, wherein the actual editing behavior identification means comprises means for identifying the first actual editing behavior applied by the user to the document editing system to edit an original version of one of the first plurality of documents and thereby to produce an edited document; and wherein the statistic derivation means comprises means for identifying the potential editing behavior based on the first actual editing behavior and a difference between the original version of the document and the edited document.

49. The apparatus of claim 34, wherein the actual editing behavior identification means comprises means for identifying a difference between a start time and an end time of the first actual editing behavior, and wherein the statistic derivation means comprises means for identifying the potential editing behavior based on the first actual editing behavior and a difference between the start time and the end time.

50. The apparatus of claim 34, further comprising:
means for generating the first plurality of documents based on a plurality of spoken audio streams using an automatic document transcription system before the actual editing behavior identification means identifies the first actual editing behavior.

51. The apparatus of claim 34, wherein the actual editing behavior identification means comprises:
means for monitoring typed input provided by at least one user to create the first plurality of documents.

52. The apparatus of claim 34, wherein the statistic derivation means comprises means for deriving a first plurality of statistics from the first actual editing behavior, and wherein the apparatus further comprises:
means for deriving a first aggregate score for the user from the first plurality of statistics; and
means for providing the first aggregate score to the user.

53. The apparatus of claim 52, further comprising:
means for identifying second editing behavior applied by a user to the document editing system to edit a second plurality of documents;
means for deriving a second aggregate score for the user from the second plurality of statistics; and
means for providing the second aggregate score to the user.

54. The apparatus of claim 34, wherein the statistic derivation means comprises:
means for deriving a core statistic from measurement of editing behavior of the user during a single editing session; and
means for deriving a higher-level statistic from the core statistic.

55. The apparatus of claim 34, wherein the statistic derivation means comprises:
means for deriving a first core statistic from measurement of first editing behavior of the user during a single editing session;
means for deriving a second core statistic from measurement of second editing behavior of the user during the single editing session; and
means for deriving a higher-level statistic from the first and second core statistics.

56. The apparatus of claim 34, further comprising:
means for providing to the user a graphical display of the first actual editing behavior.

57. A computer-implemented method for use with a document editing system and a plurality of documents, the method comprising:
(A) identifying actual editing behavior applied by a user to the document editing system to edit the plurality of documents; and
(B) identifying a modification to the document editing system based on the actual editing behavior.

58. The method of claim 57, further comprising:
(C) making the modification to the document editing system.

59. The method of claim 57, wherein (B) comprises identifying a modification to a default value of a parameter of the document editing system.

60. The method of claim 59, wherein the parameter comprises audio stream playback speed.

61. The method of claim 59, wherein the parameter comprises speech recognition confidence threshold.

62. The method of claim 57, wherein (A) comprises identifying use of a feature of the document editing system by the user, and wherein the method further comprises:
(C) deriving a statistic from the identified editing behavior; and
(D) determining, based on the statistic, whether the identified editing behavior has a positive correlation with an editing efficiency of the user; and
wherein statistic derivation means comprises determining that the feature should be removed from the document editing system if the identified editing behavior does not have a positive correlation with the editing efficiency of the user.

63. The method of claim 57, wherein (A) comprises:
(A) (1) identifying a feature of the document editing system;
(A) (2) identifying first actual editing behavior, including use of the identified feature, applied by the user to the document editing system; and
(A) (3) identifying second actual editing behavior, not including use of the identified feature, applied by the user to the document editing system;
wherein (B) comprises:
(B) (1) identifying a first editing efficiency of the user in relation to the first actual editing behavior;
(B) (2) identifying a second editing efficiency of the user in relation to the second actual editing behavior; and
(B) (3) if the second editing efficiency is lower than the first editing efficiency, then determining that the feature should be removed from the document editing system.

64. An apparatus for use with a document editing system and a plurality of documents, the apparatus comprising:
actual editing behavior identification means for identifying actual editing behavior applied by a user to the document editing system to edit the plurality of documents; and
modification identification means for identifying a modification to the document editing system based on the actual editing behavior.

65. The apparatus of claim 64, further comprising:
means for making the modification to the document editing system.

66. The apparatus of claim 64, wherein the modification identification means comprises means for identifying a modification to a default value of a parameter of the document editing system.

67. The apparatus of claim 64, wherein the actual editing behavior identification means comprises means for identifying use of a feature of the document editing system by the user, and wherein the apparatus further comprises:
means for deriving a statistic from the identified editing behavior; and
means for determining, based on the statistic, whether the identified editing behavior has a positive correlation with an editing efficiency of the user; and
wherein the modification identification means comprises means for determining that the feature should be removed from the document editing system if the identified editing behavior does not have a positive correlation with the editing efficiency of the user.

68. The apparatus of claim 64, wherein the actual editing behavior identification means comprises:
means for identifying a feature of the document editing system;
means for identifying first actual editing behavior, including use of the identified feature, applied by the user to the document editing system; and
means for identifying second actual editing behavior, not including use of the identified feature, applied by the user to the document editing system;
wherein the modification identification means comprises:
means for identifying a first editing efficiency of the user in relation to the first actual editing behavior;
means for identifying a second editing efficiency of the user in relation to the second actual editing behavior; and
means for determining that the feature should be removed from the document editing system if the second editing efficiency is lower than the first editing efficiency.

69. A computer-implemented method for use with a document editing system and a plurality of documents, the method comprising:
(A) identifying actual editing behavior applied by a user to the document editing system to edit the plurality of documents; and
(B) determining whether the actual editing behavior satisfies a plurality of predetermined criteria for preferred user editing behavior, the plurality of predetermined criteria comprising:
(1) an efficiency criterion defining a minimum efficiency threshold for editing behavior; and
(2) an accuracy criterion defining a minimum accuracy threshold for editing behavior.

70. The method of claim 69, further comprising:
(C) if the actual editing behavior satisfies the plurality of predetermined criteria, then providing the user with an indication that the actual editing behavior satisfies the plurality of predetermined criteria.

71. The method of claim 69, wherein (A) comprises:
(A) (1) monitoring input provided by the user to the document editing system to edit the plurality of documents; and
(A) (2) storing a record of the monitored input.

72. An apparatus for use with a document editing system and a plurality of documents, the apparatus comprising:
actual editing behavior identification means for identifying actual editing behavior applied by a user to the document editing system to edit the plurality of documents; and
criteria determination means for determining whether the actual editing behavior satisfies a plurality of predetermined criteria for preferred user editing behavior, the plurality of predetermined criteria comprising:
an efficiency criterion defining a minimum efficiency threshold for editing behavior; and
an accuracy criterion defining a minimum accuracy threshold for editing behavior.

73. The apparatus of claim 72, further comprising:
means for providing the user with an indication that the actual editing behavior satisfies the plurality of predetermined criteria if the actual editing behavior satisfies the plurality of predetermined criteria.

74. The apparatus of claim 72, wherein the actual editing behavior identification means comprises:
means for monitoring input provided by the user to the document editing system to edit the plurality of documents; and
means for storing a record of the monitored input.

75. A computer-implemented method for use with a document editing system and a plurality of documents, the method comprising:
(A) identifying a presentation of recorded actual editing behavior applied by a user to the document editing system to edit the plurality of documents; and
(B) determining whether the actual editing behavior satisfies at least one predetermined criterion for preferred user editing behavior based on the presentation.

76. An apparatus for use with a document editing system and a plurality of documents, the apparatus comprising:
means for identifying a presentation of recorded actual editing behavior applied by a user to the document editing system to edit the plurality of documents; and
means for determining whether the actual editing behavior satisfies at least one predetermined criterion for preferred user editing behavior based on the presentation.

77. A computer-implemented method for use with a document editing system and an original version of a document, the method comprising:
(A) identifying actual editing behavior applied by a user to the document editing system to edit the original version of the document and thereby to produce an edited version of the document, the editing behavior having an original temporal profile;
(B) recording the actual editing behavior to produce a record of the actual editing behavior;
(C) applying the actual editing behavior from the record to the document editing system in accordance with the original temporal profile to edit the original version of the document.

78. The method of claim 77, wherein (C) comprises applying the actual editing behavior from the record to the document editing system with a temporal profile that is substantially equal to the original temporal profile.

79. The method of claim 77, wherein (A) comprises identifying all actual editing behavior applied by the user to the document editing system to edit the original version of the document.

80. The method of claim 79, wherein (A) comprises identifying all keyboard input, mouse input, and foot pedal input provided by the user to the document editing system to edit the original version of the document.

81. An apparatus for use with a document editing system and an original version of a document, the apparatus comprising:
means for identifying actual editing behavior applied by a user to the document editing system to edit the original version of the document and thereby to produce an edited version of the document, the editing behavior having an original temporal profile;
means for recording the actual editing behavior to produce a record of the actual editing behavior;
means for applying the actual editing behavior from the record to the document editing system in accordance with the original temporal profile to edit the original version of the document.

82. A computer-implemented method for use with a document editing system and a first plurality of documents, the method comprising:
(A) identifying first actual editing behavior of a predetermined type, applied by a first user to the document editing system to edit the first plurality of documents;
(B) deriving a first productivity assessment of the first user from the first identified editing behavior;
(C) identifying second actual editing behavior of the predetermined type, applied by a second user to the document editing system to edit the second plurality of documents;
(D) deriving a second productivity assessment of the second user from the second identified editing behavior; and
(E) deriving, from the first and second productivity assessments, a behavioral metric indicating a degree of correlation between editing behavior of the predetermined type and productivity.

83. An apparatus for use with a document editing system and a first plurality of documents, the apparatus comprising:
means for identifying first actual editing behavior of a predetermined type, applied by a first user to the document editing system to edit the first plurality of documents;
means for deriving a first productivity assessment of the first user from the first identified editing behavior;
means for identifying second actual editing behavior of the predetermined type, applied by a second user to the document editing system to edit the second plurality of documents;
means for deriving a second productivity assessment of the second user from the second identified editing behavior; and
means for deriving, from the first and second productivity assessments, a behavioral metric indicating a degree of correlation between editing behavior of the predetermined type and productivity.
